(19) United States
(12) Patent Application Publication
(10) Pub. No.: US 2016/0194211 A1
(43) Pub. Date: Jul. 7, 2016

(54) OPERATIONAL CONTROLS FOR INERT GAS BLANKETING FOR ANDRUSSOW PROCESS

(71) Applicant: INVISTA TECHNOLOGIES S.A R.L., Wilmington, DE (US)

(72) Inventors: John C. CATON, Yoakum, TX (US); John F. GEHRKE, Inez, TX (US); Gary L. CARRIER, Victoria, TX (US)

(73) Assignee: INVISTA NORTH AMERICA S.A R.L., Wilmington, DE (US)

(21) Appl. No.: 14/741,762

(22) PCT Filed: Dec. 12, 2013
(86) PCT No.: PCT/US2013/074544

§ 371 Date: Jun. 17, 2015

Related U.S. Application Data
(60) Provisional application No. 61/738,829, filed on Dec. 18, 2012.

(51) Int. Cl. C01C 3/02

(52) U.S. Cl. CPC C01C 3/0212; C01C 3/022

(57) ABSTRACT

The present invention relates to a system and a process for producing hydrogen cyanide and more particularly, to a process for controlling operational stability of the system and process by blanketing the system with inert gas. More particularly, the present invention relates to the flushing of the system with an inert gas when a crude hydrogen cyanide product exceeds a threshold of oxygen, such as greater than 0.4 vol. % oxygen.

### CROSS REFERENCE TO RELATED APPLICATION

This application claims priority to U.S. App. No. 61/738,829, filed Dec. 18, 2012, the entire contents and disclosures of which are incorporated herein.

### FIELD OF THE INVENTION

The present invention is directed to an inert gas blanketing system. This system may be used within the process for manufacturing hydrogen cyanide using the Andrussow process. In particular, the present invention is directed to reaction assemblies used to produce hydrogen cyanide and to controlling the oxygen content in a crude hydrogen cyanide product.

### BACKGROUND OF THE INVENTION

Conventionally, hydrogen cyanide (“HCN”) is produced on an industrial scale according to either the Andrussow process or the BMA process. (See e.g., Ullman's Encyclopedia of Industrial Chemistry, Volume A8, Weinheim 1987, pages 161-163). For example, in the Andrussow process, HCN can be commercially produced by reacting ammonia with a methane-containing gas and an oxygen-containing gas at elevated temperatures in a reactor in the presence of a suitable catalyst (U.S. Pat. Nos. 1,934,838 and 6,596,251). Sulfur compounds and higher homologues of methane may have an effect on the parameters of oxidative ammonolysis of methane. See, e.g., Trusov, Effect of Sulfur Compounds and Higher Homologues of Methane on Hydrogen Cyanide Production by the Andrussow Method, Russian J. Applied Chemistry, 74:10 (2001), pp. 1693-1697). Unreacted ammonia is separated from HCN by contacting the reactor effluent gas stream with an aqueous solution of ammonium phosphate in an ammonia absorber. The separated ammonia is purified and concentrated for recycle to HCN conversion. HCN is recovered from the treated reactor effluent gas stream typically by absorption into water. The recovered HCN may be treated with further refining steps to produce purified HCN. Clean Development Mechanism Project Design Document Form (CDM PDD, Version 3), 2006, schematically explains the Andrussow HCN production process. Purified HCN can be used in hydrocyanation, such as hydrocyanation of an olefin-containing group, or such as hydrocyanation of 1,3-butadiene and pentenenitrile, which can be used in the manufacture of adiponitrile (“ADN”). In the BMA process, HCN is synthesized from methane and ammonia in the substantial absence of oxygen and in the presence of a platinum catalyst, resulting in the production of HCN, hydrogen, nitrogen, residual ammonia, and residual methane (See e.g., Ullman's Encyclopedia of Industrial Chemistry, Volume A8, Weinheim 1987, pages 161-163). Commercial operators require process safety management to handle the hazardous properties of hydrogen cyanide. (See Maxwell et al. Assuring process safety in the transfer of hydrogen cyanide manufacturing technology, JHazMat 142 (2007), 677-684). Additionally, emissions of HCN production processes from production facilities may be subject to regulations, which may affect the economics of HCN manufacturing. (See Crump, Economic Impact Analysis For The Proposed Cyanide Manufacturing NESHAP, EPA, May 2000).

U.S. Pat. No. 2,797,148 discloses the recovery of ammonia from a gaseous mixture containing ammonia and hydrogen cyanide. A reaction off-gas, from the process of preparing hydrogen cyanide by reacting ammonia with a hydrocarbon-bearing gas and an oxygen-containing gas, comprises ammonia, hydrogen cyanide, hydrogen, nitrogen, water vapor and carbon oxides. The off-gas is cooled to a temperature of 55 to 90° C. and is then led into an absorption tower for separation of ammonia from the off-gas.

Although the Andrussow process and recovery of hydrogen cyanide are known, there has been little if any disclosure related to 1) an inert gas blanketing system or 2) process controls for monitoring and controlling the oxygen content in a crude hydrogen cyanide product or in an ammonia absorber off-gas stream when the ternary gas mixture comprises at least 25 vol. % oxygen.

Thus, the need exists for processes that produce hydrogen cyanide in the presence of a catalyst and that can also monitor and control the amount of oxygen in a crude hydrogen cyanide product or in an off-gas stream.

The publications mentioned above are hereby incorporated by reference.

### SUMMARY OF THE INVENTION

In a first embodiment, the present invention is directed to a reaction assembly for producing hydrogen cyanide, the system comprising: an inert gas storage unit; a mixing vessel comprising a first inlet port for ternary gas mixture components comprising a methane-containing gas, an ammonia-containing gas, and an oxygen-containing gas; and a reactor comprising a second inlet port, at least one outlet port, and an internal reaction chamber comprising a catalyst bed containing a catalyst; a crude hydrogen cyanide product diverting valve free of polytetrafluoroethylene; wherein the inert gas storage unit is pressurized to 1300 to 1600 kPa; and further wherein the inert gas storage unit is configured to fed an inert gas to the mixing vessel.

In a second embodiment, the present invention is directed to a reaction assembly for producing hydrogen cyanide, the system comprising: an inert gas storage unit; a first conduit for introducing an oxygen-containing gas into the reaction assembly and a valve, wherein the first conduit is connected to the inert gas storage unit for feeding an inert gas upstream of the valve; a second conduit for introducing a binary gas mixture into the reaction assembly; a reactor comprising at least one outlet port, an internal reaction chamber comprising a catalyst bed containing a catalyst; and a crude hydrogen cyanide product diverting valve free of polytetrafluoroethylene; wherein the inert gas storage unit is pressurized to 1300 to 1600 kPa.

In a third embodiment, the present invention is directed to a process for producing hydrogen cyanide, comprising: providing components of a ternary gas mixture, which comprises a methane-containing gas, an ammonia-containing gas, and an oxygen-containing gas; introducing the components of the ternary gas mixture into a mixing vessel included in a reaction assembly to form a ternary gas mixture comprising at least 25 vol. % oxygen; contacting the ternary gas mixture with a catalyst to provide a crude hydrogen cyanide product; flushing the reaction assembly with an inert gas when the crude hydrogen cyanide product comprises more than a threshold of oxygen; and diverting the crude hydrogen cyanide product from separation process equipment by activating a valve free of polytetrafluoroethylene. The inert gas may be selected from the group consisting of nitrogen, helium, carbon dioxide, argon and mixtures thereof. In some embodiments, the inert gas is nitrogen. The components of the ternary gas mixture may comprise an oxygen-containing gas, a methane-containing gas and an ammonia-containing gas. The oxygen-containing gas may comprise greater than 21 vol. % oxygen. The flushing may comprise ceasing the oxygen-containing gas flow and flushing the reaction assembly with the inert gas. The oxygen-containing gas flow may be ceased by activating a valve. The ternary gas mixture may comprise from 25 vol. % to 32 vol. % oxygen. The inert gas may be selected from the group consisting of nitrogen, helium, carbon dioxide, argon and mixtures thereof. In some embodiments, the inert gas may be nitrogen. The flushing may provide a reactor discharge comprising inert gas, methane, ammonia, and HCN. The reactor discharge may be purged. The threshold of oxygen may be measured using an oxygen sensor. The threshold of oxygen may be further measured in an off-gas stream, wherein the threshold of oxygen in the off-gas stream is higher than the threshold of oxygen in the crude hydrogen cyanide product.

In a fourth embodiment, the present invention is directed to a process for producing hydrogen cyanide, comprising: providing components of a ternary gas mixture, which comprises a methane-containing gas, an ammonia-containing gas, and an oxygen-containing gas; introducing the components of the ternary gas mixture into a mixing vessel included in a reaction assembly to form a ternary gas mixture comprising at least 25 vol. %; contacting the ternary gas mixture with a catalyst to provide a crude hydrogen cyanide product; separating the crude hydrogen cyanide product to form an off-gas stream and a hydrogen cyanide product stream; flushing the reaction assembly with an inert gas when the off-gas stream comprises more than 1 vol. % oxygen; and diverting the crude hydrogen cyanide product from separation process equipment by activating a valve free of polytetrafluoroethylene. The inert gas may be selected from the group consisting of nitrogen, helium, carbon dioxide, argon and mixtures thereof. In some embodiments, the inert gas is nitrogen. The components of the ternary gas mixture may comprise an oxygen-containing gas, a methane-containing gas and an ammonia-containing gas. The oxygen-containing gas may comprise greater than 21 vol. % oxygen. The flushing may comprise ceasing the oxygen-containing gas flow and flushing the reaction assembly with the inert gas. The oxygen-containing gas flow may be stopped by activating a valve. The ternary gas mixture may comprise from 25 vol. % to 32 vol. % oxygen. The inert gas may be selected from the group consisting of nitrogen, helium, carbon dioxide, argon and mixtures thereof. In some embodiments, the inert gas may be nitrogen. The flushing may provide a reactor discharge comprising inert gas, methane, ammonia, and HCN. The reactor discharge may be purged.

In a fifth embodiment, the present invention is directed to a process for controlling operational stability of a process for producing hydrogen cyanide, comprising: providing components of a ternary gas mixture to a reaction assembly, wherein the components of the ternary gas mixture comprise a methane-containing gas, an ammonia-containing gas, and an oxygen-containing gas; mixing the ternary gas mixture components to form a ternary gas mixture comprising at least 25 vol. % oxygen; contacting the ternary gas mixture with a catalyst to provide a crude hydrogen cyanide product; determining an oxygen content in the crude hydrogen cyanide product; feeding an inert gas to the reaction assembly when oxygen content in the crude hydrogen cyanide product is greater than an oxygen threshold, such as 0.4 vol. %; and activating a valve free of polytetrafluoroethylene to divert the crude hydrogen cyanide product from separation equipment. In some embodiments, the ternary gas mixture comprises greater than 25 vol. % oxygen, or from 25 to 32 vol. % oxygen. The inert gas may be selected from the group consisting of nitrogen, helium, carbon dioxide, argon and mixtures thereof. In some embodiments, the inert gas is nitrogen. Determination of the oxygen content may comprise measuring oxygen content of the crude hydrogen cyanide product as it exits the reaction assembly. The reaction assembly may comprise a mixing vessel and a reactor. The inert gas may be fed to the mixing vessel. When inert gas is fed to the mixing vessel, the ternary gas mixture may be adjusted to comprise 0 to 25 vol. % oxygen. The inert gas may be fed into the reactor at a velocity sufficient to cause the oxygen content of the reaction product to be less than 0.2 vol. %. The flushing may provide a reactor discharge comprising inert gas, methane, ammonia, and HCN. The reactor discharge may be purged.

### BRIEF DESCRIPTION OF THE DRAWINGS

FIG. 1 is a schematic representation of an HCN production and recovery system in accordance with an embodiment of the present invention.

### DETAILED DESCRIPTION OF THE INVENTION

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, group of elements, components, and/or groups thereof.

Language such as “including,” “comprising,” “having,” “containing,” or “involving,” and variations thereof, is intended to be broad and encompass the subject matter listed thereafter, as well as equivalents, and additional subject matter not recited. Further, whenever a composition, a group of elements, process or method steps, or any other expression is preceded by the transitional phrase “comprising,” “including,” or “containing,” it is understood that it is also contemplated herein the same composition, group of elements, process or method steps or any other expression with transitional phrases “consisting essentially of,” “consisting of” or “selected from the group consisting of,” preceding the recitation of the composition, the group of elements, process or method steps or any other expression.

The corresponding structures, materials, acts, and equivalents of all means or step plus function elements in the claims, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments described were chosen and described in order to best explain the principles of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

Reference will now be made in detail to certain disclosed subject matter. While the disclosed subject matter will be described in conjunction with the enumerated claims, it will be understood that they are not intended to limit the disclosed subject matter to those claims. On the contrary, the disclosed subject matter is intended to cover all alternatives, modifications, and equivalents, which can be included within the scope of the presently disclosed subject matter as defined by the claims.

The present invention provides a reaction assembly for producing hydrogen cyanide, a process for producing hydrogen cyanide, and a process for controlling operational stability of a process for producing hydrogen cyanide using an inert gas blanketing system. The reaction assembly includes a mixing vessel, a reactor, and pressurized inert gas, e.g., with a pressure from 1300 to 1600 kPa, stored externally from the mixing vessel and reactor. Unless otherwise indicated, all pressures are absolute. The volume of gas stored is typically larger than the volume of the reactor, which allows for flushing during high oxygen events. The process of the present invention for producing hydrogen cyanide incorporates flushing the hydrogen cyanide reaction assembly with the pressurized inert gas when the oxygen content exceeds threshold amounts. The threshold amount may be monitored in the crude hydrogen cyanide product or a derivative stream thereof, such as an off-gas stream. This threshold amount may be adjusted and may be set based on the operation condition to trigger the inert gas blanketing system to flush the reactor when the oxygen concentration exceeds acceptable levels in the crude hydrogen cyanide product. For purposes of the present invention, the inert gas blanketing system is connected to the reactor to introduce inert gases to the reactor when oxygen content exceeds threshold amounts. Similarly, the process of the present invention controls operational stability by using the pressurized inert gas when oxygen content at exceeds the threshold. As described herein, this pressurized inert gas may be used in combination with producing hydrogen cyanide, especially when the hydrogen cyanide production process uses oxygen-enhanced air or pure oxygen as a reactant.

In the Andrussow process for forming HCN, methane, ammonia and oxygen raw materials are reacted at temperatures above about 1000° C. in the presence of a catalyst to produce a crude hydrogen cyanide product comprising HCN, hydrogen, carbon monoxide, carbon dioxide, nitrogen, residual ammonia, residual methane, and water. The reaction occurs in a reaction assembly comprising a mixing vessel and a reactor. The raw materials, also referred to as an oxygen-containing gas, an ammonia-containing gas and a methane-containing gas, are provided to the mixing vessel to form a ternary gas mixture. Natural gas is typically used as the source of methane, while air, oxygen-enriched air, or pure oxygen can be used as the source of oxygen. The ternary gas mixture is passed over a catalyst to form a crude hydrogen cyanide product. The crude hydrogen cyanide product is then separated to recover HCN.

The catalyst is typically a wire mesh platinum/rhodium alloy or a wire mesh platinum/iridium alloy. Other catalyst compositions can be used and include, but are not limited to, a platinum group metal, platinum group metal alloy, supported platinum group metal or supported platinum group metal alloy. Other catalyst configurations can also be used and include, but are not limited to, porous structures including woven, non-woven and knitted configurations, wire gauze, tablets, pellets, monoliths, foams, impregnated coatings, and wash coatings. The catalyst must be sufficiently strong to withstand increased velocity rates that may be used in combination with a ternary gas mixture comprising at least 25 vol. % oxygen. Thus, a 85/15 platinum/rhodium alloy may be used on a flat catalyst support. A 90/10 platinum/rhodium alloy may be used with a corrugated support that has an increased surface area as compared to the flat catalyst support.

The term “air” as used herein refers to a mixture of gases with a composition approximately identical to the native composition of gases taken from the atmosphere, generally at ground level. In some examples, air is taken from the ambient surroundings. Air has a composition that includes approximately 78 vol. % nitrogen, approximately 21 vol. % oxygen, approximately 1 vol. % argon, and approximately 0.04 vol. % carbon dioxide, as well as small amounts of other gases.

The term “oxygen-enriched air” as used herein refers to a mixture of gases with a composition comprising more oxygen than is present in air. Oxygen-enriched air has a composition including greater than 21 vol. % oxygen, less than 78 vol. % nitrogen, less than 1 vol. % argon and less than 0.04 vol. % carbon dioxide. In some embodiments, oxygen-enriched air comprises at least 28 vol. % oxygen, e.g., at least 80 vol. % oxygen, at least 95 vol. % oxygen, or at least 99 vol. % oxygen.

The formation of HCN in the Andrussow process is often represented by the following generalized reaction:

2CH₄+2NH₃+3O₂→2HCN+6H₂O

However, it is understood that the above reaction represents a simplification of a much more complicated kinetic sequence where a portion of the hydrocarbon is first oxidized to produce the thermal energy necessary to support the endothermic synthesis of HCN from the remaining hydrocarbon and ammonia.

Three basic side reactions also occur during the synthesis of HCN:

CH₄+H₂O→CO+3H₂

2CH₄+3O₂→2CO+4H₂O

4NH₃+3O₂→2N₂+6H₂O

In addition to the amount of nitrogen generated in the side reactions, additional nitrogen may be present in the crude product, depending on the source of oxygen. Although the prior art has suggested that oxygen-enriched air or pure oxygen can be used as the source of oxygen, the advantages of using oxygen-enriched air or pure oxygen have not been fully explored. When using air as the source of oxygen, the crude hydrogen cyanide product comprises the components of air, e.g., approximately 78 vol. % nitrogen, and the nitrogen produced in the ammonia and oxygen side reaction.

Due to the large amount of nitrogen, it is advantageous to use oxygen-enriched air in the synthesis of HCN because the use of air as the source of oxygen in the production of HCN results in the synthesis being performed in the presence of a large volume of inert gas (nitrogen) necessitating the use of larger equipment in the synthesis step and resulting in a lower concentration of HCN in the product gas. Additionally, because of the presence of the inert nitrogen, more methane is required to be combusted in order to raise the temperature of the ternary gas mixture components to a temperature at which HCN synthesis can be sustained. The crude hydrogen cyanide product contains the HCN and also by-product hydrogen, methane combustion byproducts (carbon monoxide, carbon dioxide, water), residual methane, and residual ammonia. However, when using air (i.e., 21 vol. % oxygen), after separation of the HCN and recoverable ammonia from the other gaseous components, the presence of the inert nitrogen renders the residual gaseous stream with a fuel valve that may be lower than desirable for energy recovery.

Therefore, the use of oxygen-enriched air or pure oxygen instead of air in the production of HCN provides several benefits, including the ability to recover hydrogen, an increase in the conversion of natural gas to HCN and a concomitant reduction in the size of process equipment. Thus, the use of oxygen-enriched air or pure oxygen reduces the size of the reactor and at least one component of the downstream gas handling equipment through the reduction of inert compounds entering the synthesis process. The use of oxygen-enriched air or pure oxygen also reduces the energy consumption required to heat the oxygen-containing gas to reaction temperature.

However, the increased amount of oxygen and decreased amount of nitrogen raises concerns regarding process safety. The amount of oxygen present in the ternary gas mixture is controlled by flammability limits. Certain combinations of air, methane and ammonia are flammable and will therefore propagate a flame following ignition. A mixture of air, methane and ammonia will burn if the gas composition lies between the upper and lower flammability limits. Mixtures of air, methane and ammonia outside of this region are typically not flammable. The use of oxygen-enriched air changes the concentration of combustibles in the ternary gas mixture. Increasing the oxygen content in the oxygen-containing gas feed stream significantly broadens the flammable range. For example, a mixture containing 45 vol. % air and 55 vol. % methane is considered very fuel-rich and is not flammable, whereas a mixture containing 45 vol. % oxygen and 55 vol. % methane is flammable. An additional concern is the detonation limit. For example, at atmospheric pressure and room temperature, a gas mixture containing 60 vol. % oxygen, 20 vol. % methane and 20 vol. % ammonia can detonate.

Thus, while the use of oxygen-enriched air or pure oxygen in the production of HCN has been found to be advantageous, the enrichment of air with oxygen necessarily leads to a change in the concentration of combustibles in the ternary gas mixture and such a change in the concentration of combustibles increases the upper flammability limit of the ternary gas mixture fed to the reactor. Deflagration and detonation of the ternary gas mixture is, therefore, sensitive to the oxygen concentration. The term “deflagration” as used herein refers to a combustion wave propagating at subsonic velocity relative to the unburned gas immediately ahead of the flame. “Detonation,” on the other hand, refers to a combustion wave propagating at supersonic velocity relative to the unburned gas immediately ahead of the flame. Deflagrations typically result in modest pressure rise whereas detonations can lead to extraordinary pressure rise.

While others have suggested use of oxygen-enriched air for increasing HCN production capacity, they typically avoid operating in the flammable region. See U.S. Pat. Nos. 5,882,618; 6,491,876 and 6,656,442, the entireties of which are incorporated herein by reference. In the present invention, the oxygen-enriched air or pure oxygen feed is controlled to form a ternary gas mixture within the flammable region, but not within the detonable region. Thus, in some embodiments, the ternary gas mixture comprises greater than 25 vol. % oxygen, e.g., greater than 28 vol. % oxygen. In some embodiments, the ternary gas mixture may comprise from 25 to 32 vol. % oxygen, e.g., 26 to 30 vol. % oxygen. The ternary gas mixture may have a molar ratio of ammonia-to-oxygen from 1.2 to 1.6 e.g., from 1.3 to 1.5, a molar ratio of ammonia-to-methane from 1 to 1.5, e.g., from 1.1 to 1.45, and a molar ratio of methane-to-oxygen from 1 to 1.25, e.g., from 1.05 to 1.15. For example, a ternary gas mixture may have a molar ratio of ammonia-to-oxygen of 1.3 and methane-to-oxygen of 1.2. In another exemplary embodiment, the ternary gas mixture may have a molar ratio of ammonia-to-oxygen of 1.5 and methane-to-oxygen of 1.15. The oxygen concentration in the ternary gas mixture may vary depending on these molar ratios.

Use of oxygen-enriched air and stable operation in the flammable region can be achieved and generally requires more careful monitoring of the ammonia-to-oxygen and methane-to-oxygen molar ratios than is necessary for the operation of a non-oxygen-enriched process. For example, when operating within the flammable region with 28 vol. % oxygen, a loss of methane or ammonia flow could be stabilized by monitoring and controlling the system to prevent the resulting ternary gas mixture from transitioning to a mixture having a composition in the detonable region. This monitoring and controlling may include measuring the oxygen content at certain points within the HCN production system.

To control the oxygen content and to maintain operational stability, a reaction assembly comprising inert gas 101 from an inert gas storage unit, a mixing vessel and a reactor 106 (shown as one unit) may be utilized. Although only one reactor unit is shown, it is understood that in some embodiments, two or three reactors may be used, in parallel. In some embodiments, the inert gas is stored separately from the mixing vessel and reactor, and may be stored at a pressure from 1300 to 1600 kPa, e.g., from 1350 to 1550 kPa or from 1400 to 1500 kPa. The mixing vessel comprises a first inlet port for ternary gas mixture components. The components include an oxygen-containing gas 102 comprising greater than 21 vol. % oxygen, a methane-containing gas 103, and an ammonia-containing gas 104. The first inlet port may comprise at least two mixture component conduits. The first conduit may be used to feed the oxygen-containing gas to the first inlet port. The second conduit may be used to feed a binary gas mixture 105 comprising the methane-containing gas and the ammonia-containing gas to the first inlet port. In some embodiments, the second conduit may be used to feed the methane-containing gas to the first inlet port and a third conduit may be used to feed the ammonia-containing gas to the first inlet port.

In additional embodiments, the mixing vessel may comprise two inlet ports or three inlet ports (not shown). When the mixing vessel comprises two inlet ports, the oxygen-containing gas is fed to one inlet port and a binary gas mixture comprising the methane-containing gas and the ammonia-containing gas is fed to the other inlet port. When the mixing vessel comprises three inlet ports, the oxygen-containing gas 102 is fed to one inlet port, the methane-containing gas 103 is fed to one inlet port, and the ammonia-containing gas 104 is fed to one inlet port.

The ternary gas mixture components are mixed in the mixing vessel to form a ternary gas mixture, which then flows through the second inlet port to the reactor. In the reactor, the ternary gas mixture flows through an internal reaction chamber comprising a catalyst bed containing a catalyst. The ternary gas mixture is reacted in the presence of the catalyst to form a crude hydrogen cyanide product 107. This crude hydrogen cyanide product 107 then exits the reactor through an outlet port and may be subjected to processing and/or separation steps.

In some embodiments, the oxygen content of the crude hydrogen cyanide product 107 may be measured as the crude hydrogen cyanide product 107 exits the reactor using sensor 108. Sensor 108 may be a GC sensor that monitors concentrations in real-time or in near real-time. Sensor 108 is capable of detecting low levels of oxygen. Under normal operating conditions, oxygen concentration in the crude hydrogen cyanide product is low because oxygen is typically consumed during the reaction. Thus, oxygen concentrations may vary from 0 to 0.2 vol. % under normal operating conditions. The threshold amount of oxygen to trigger the inert gas blanketing system is typically set above the normal expected oxygen concentration in the crude hydrogen cyanide product. For purposes of the present invention, the threshold oxygen concentration may be selected from any value between 0.2 vol. % oxygen and 5 vol. % oxygen, e.g., between 0.2 vol. % oxygen and 2 vol. % oxygen or between 0.3 vol. % oxygen and 1 vol. % oxygen. Setting the threshold at a lower value is preferred to avoid having a large amount of oxygen leak through into the crude hydrogen cyanide product. However, setting the value too low may trigger unnecessary flushing that leads to production down time. The system may tolerate oxygen concentrations above the normal amounts, and thus the threshold may be set at a value greater than 0.4 vol. % oxygen, e.g., greater than 0.3 vol. % or greater than 0.2 vol. %. When the oxygen content is above a threshold, e.g., greater than 0.4 vol. % oxygen, greater than 0.3 vol. % or greater than 0.2 vol. %, the reaction assembly may be flushed with inert gas, e.g., nitrogen, via line 101. The flushing with inert gas should occur very rapidly to avoid a further increase in oxygen concentration in the crude hydrogen cyanide product. The threshold of greater than 0.4 vol. % oxygen, e.g., greater than 0.3 vol. % or greater than 0.2 vol. % is selected based on the amount of oxygen in the crude hydrogen cyanide product that would begin to indicate a system upset. A system upset should preferably be detected as earlier as possible to avoid further loss of conversion and to avoid operating in unsafe conditions. Monitoring oxygen concentration in the crude hydrogen cyanide product achieves an early detection of potential or actual system upsets. An oxygen amount of greater than 0.4 vol. %, greater than 0.3 vol. % or greater than 0.2 vol. %, may indicate a production problem such as (1) oxygen is bypassing the catalyst bed; (2) reaction conversion is decreased; or (3) the feed ratios of methane and/or ammonia to oxygen are not on-spec in the reactor which may move the ternary gas to the denotation range. In addition, larger concentrations of oxygen in the crude hydrogen cyanide product 107 may present separation difficulties and due to poor conversions may make recovering hydrogen cyanide more costly.

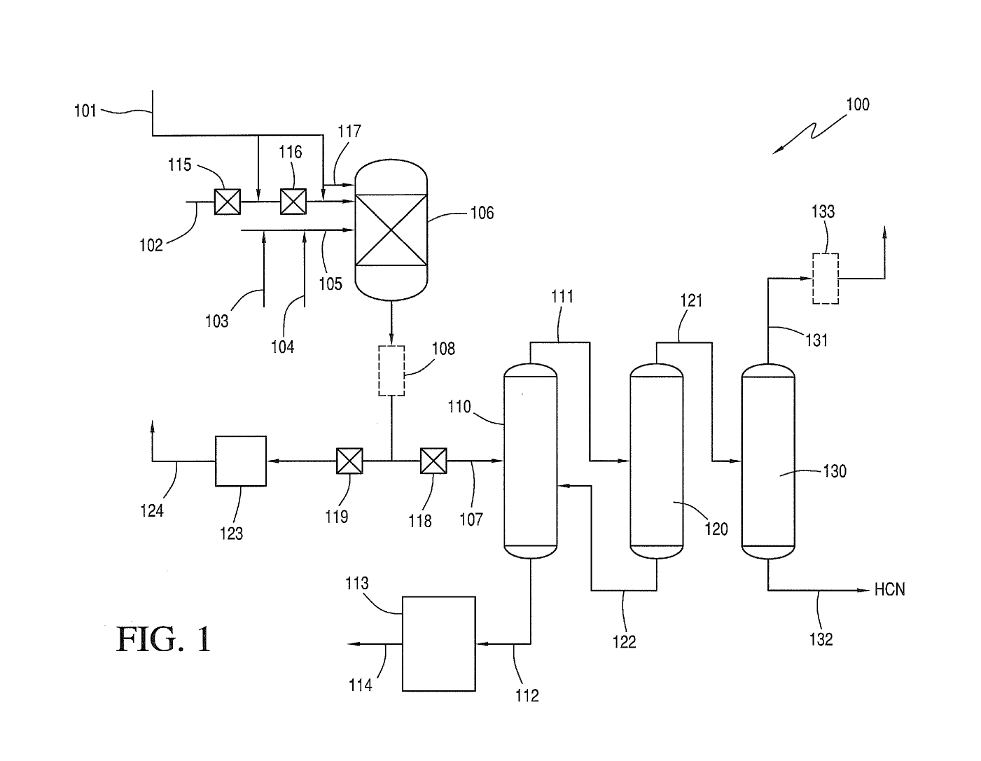

As shown in FIG. 1, oxygen-containing gas 102 is directed to the reactor through a conduit that contains valves 115 and 116. When a system upset occurs, e.g., the oxygen content is above the threshold, feed valves 115 and 116 are closed almost immediately after sensor 108 detects higher concentrations of oxygen. Valves 115 and 116 may be comprised of stainless steel. Inert gas is fed between feed valves 115 and 116 and also to a point in the conduit downstream of valve 116. Feeding to both locations further assists in purging any remaining oxygen from the conduit. This feeding of inert gas between feed valves 115 and 116 and then to a point in the conduit downstream of valve 116 may be concurrent or sequential. The inert gas may be nitrogen, helium, argon, carbon dioxide, and mixtures thereof. In some aspects, the inert gas is nitrogen. When the inert gas is fed to the reaction assembly, due to oxygen content being determined and reaching a threshold as defined herein, the oxygen-containing gas flow is reduced or stopped.

In some embodiments, the inert gas may also be fed directly to mixing vessel 106 via line 117. The ammonia-containing gas 104 and the methane-containing gas 103 may continue to flow through reactor 106 or may be shut off to avoid a loss of reactants. When valves 115 and 116 are closed, valve 118 is also closed. The closure of valve 118 prevents the outlet flow of reactor 106 from entering the separation portion of the HCN production process. Additionally, when valves 115, 116 and 118 are closed, valve 119 is concurrently opened to allow the outlet flow of reactor 106 to flow to flare 123, where the outlet flow may be burned and expelled from the system via line 124. The addition of large volumes of inert gas to the reactor suppresses the reaction and stops the production of hydrogen cyanide. Thus recovery of hydrogen cyanide from the reactor effluent with the inert gas flush is impractical and the reactor effluent is preferably purged. Each feed valve 115 and 116 may be connected to a pressurized inert gas storage tank. The pressurized inert gas storage tank has a sufficient volume to rapidly replace the volume of the reactor. In the event of a power failure, the pressure in the storage tank is sufficient to allow the required velocity to purge oxygen from the system, e.g., from 1300 to 1600 kPa. The valves may be designed to withstand a crude hydrogen cyanide product with a temperature of greater than 200° C. Valves 118 and 119 may be comprised of any material that can withstand, i.e., do not deform at, temperatures of greater than 200° C., including combinations of graphite and stainless steel. Valves containing a combination of graphite and stainless steel include metal seated valves sold by Kitz Corporation of America, Lunkenheimer Cincinnati Valve Company, and Forum Energy Technologies under the tradename DSI®. Polytetrafluoroethylene is insufficient for this purpose as it may deform above 200° C. Thus, the valves are free of polytetrafluoroethylene. Although the crude hydrogen cyanide product is cooled before exiting the reactor, the temperature of the crude hydrogen cyanide product is still above 200° C., e.g. above 220° C., when the oxygen source is oxygen-enhanced air or pure oxygen. No further cooling of the crude hydrogen cyanide product occurs and thus there is no downstream cooler from the reactor as typically found in an air process. Without being bound by theory, it is believed that the crude hydrogen cyanide product must be maintained above its dew point to avoid HCN polymerization. Therefore, in some embodiments, the crude hydrogen cyanide product may be diverted from the separation train, e.g., from further ammonia-recovery or HCN refining, by a valve that is free of polytetrafluroethylene when oxygen concentrations exceed a threshold. Valves 118 and 119 may also be selected to withstand pressures of up to 14 MPa.

In other embodiments, the oxygen content may be measured by a sensor 133 downstream from the reactor, such as in the reactor off-gas 131, described herein. In one aspect, sensor 108 and sensor 133 may measure oxygen concentration in at least two locations in the process. For the off-gas, the oxygen content threshold may be above 2 vol. %, e.g., above 1.5 vol. % or above 1 vol. %. The threshold of oxygen content is higher in the off-gas than in the absorber because the oxygen is more concentrated in this off-gas than in the crude hydrogen cyanide product. In some aspects, the off-gas is subjected to purification in a pressure-swing adsorber (“PSA”) to recover hydrogen. When sensor 133 measures the oxygen content in reactor off-gas 131; operational controls may be set to divert the off-gas flow from the PSA. Without being bound by theory, the off-gas flow may be diverted from the PSA when the oxygen content is greater than 1 vol. % to save energy costs associated with using the PSA when the off-gas has a higher oxygen content than is generally found in the off-gas under normal operating conditions.

Thus, the present invention is also directed to a process for controlling operational stability by determining oxygen content in the crude hydrogen cyanide product or off-gas stream, and feeding inert gas to the reaction assembly, thereby flushing the reaction assembly with inert gas. This flushing with inert gas from the inert gas blanketing system serves to rapidly reduce the oxygen content in the reaction assembly and move the ternary gas mixture out of the detonable oxygen range. The oxygen content in the crude hydrogen cyanide will be reduced to below the threshold oxygen concentration. The blanketing of inert gas also suppresses the reaction to prevent formation of crude hydrogen cyanide product.

During this flushing of the reaction assembly with inert gas, the oxygen-containing gas feed is adjusted to comprise less than 5 vol. % oxygen and greater than 80 vol. % inert gas. The adjusting depends on the initial amount of inert gas present in the oxygen-containing gas. For example, when pure oxygen is used as the oxygen-containing gas, more inert gas will need to be fed to the reaction assembly than when oxygen-enriched air comprising 23 vol. % oxygen is used as the oxygen-containing gas. Similarly, the ternary gas mixture is adjusted to comprise less than 25 vol. % oxygen, e.g., less than 15 vol. %, less than 10 vol. %, less than 5 vol. %, or substantially no oxygen.

Returning to FIG. 1, the crude hydrogen cyanide product 107 under normal operation conditions contains HCN and may also include by-product hydrogen, methane combustion byproducts (such as carbon dioxide, carbon monoxide, and water), nitrogen, residual methane, and residual ammonia. The residual ammonia may be recoverable and may be further treated and combined with ammonia-containing gas 104. Because the rate of HCN polymerization may increase with increasing pH, residual ammonia must be removed to avoid the polymerization of the HCN. HCN polymerization represents not only a process productivity problem, but an operational challenge as well, since polymerized HCN can cause process line blockages resulting in pressure increases and associated process control problems. Typically, the crude hydrogen cyanide product 107 exits the reactor at high temperature, e.g., approximately 1200° C., and is rapidly quenched to less than 400° C., less than 300° C. or less than 200° C. This quenching may be accomplished by using any known unit operation, such as a waste heat boiler. Ammonia is then separated from the crude hydrogen cyanide product 107 in the first step of the refining process, described herein, and HCN polymerization is inhibited by immediately reacting the crude hydrogen cyanide product with an excess of acid, e.g., H₂SO₄ or H₃PO₄, such that the residual free ammonia is captured by the acid as an ammonium salt and the pH of the solution remains acidic. Formic acid and oxalic acid in ammonia recovery feed stream are captured in aqueous solution in an ammonia recovery system as formates and oxalates.

The requirement of low water, and the high purity required of the HCN when it is to be used as a feed stream in a hydrocyanation process, such as the hydrocyanation of 1,3-butadiene (sometimes referred to herein as “butadiene”) and pentenenitrile to produce adiponitrile, necessitate a process of producing and processing uninhibited HCN. The term “uninhibited” is used herein to mean that the HCN is substantially free of stabilizing polymerization inhibitors. Such inhibitors would require removal prior to utilizing the HCN in, for example, hydrocyanation, such as in the manufacture of adiponitrile by hydrocyanation of 1,3-butadiene and hydrocyanation of pentenenitriles, and other conversion processes known to those skilled in the art.

Returning to FIG. 1, when residual ammonia is present, crude hydrogen cyanide product 107 is fed to ammonia absorber 110, where ammonia and hydrogen cyanide are separated to form an ammonia stream in line 112 and a hydrogen cyanide stream in line 111. A phosphate stream (not shown) may also be fed to ammonia scrubber 120. The phosphate stream may comprise phosphoric acid. In some embodiments, the phosphate stream is a dilute phosphoric acid stream. In other embodiments, alternative phosphates are used, as discussed herein.

Ammonia absorber 110 may utilize packing and/or trays. In one embodiment, the absorption stages in ammonia absorber 110 are valve trays. Valve trays are well known in the art and tray designs are selected to achieve good circulation, prevent stagnant areas, and prevent polymerization and corrosion. In order to avoid polymerization, equipment is designed to minimize stagnant areas generally wherever HCN is present, such as in ammonia absorber 110 as well as in other areas discussed below. Ammonia absorber 110 may also incorporate an entrainment separator above the top tray to minimize carryover. Entrainment separators typically include use of techniques such as reduced velocity, centrifugal separation, demisters, screens, or packing, or combinations thereof.

In another embodiment, ammonia absorber 110 is provided with packing in an upper portion of ammonia absorber 110 and a plurality of valve trays are provided in a lower portion of ammonia absorber 110. The packing acts to reduce and/or prevent ammonia and phosphate from escaping ammonia absorber 110 via hydrogen cyanide stream 111. The packing provides additional surface area for ammonia absorption while reducing entrainment in the hydrogen cyanide stream 111, resulting in an overall increased ammonia absorption capability. The packing employed in the upper portion of the ammonia absorber 110 can be any low pressure drop, structured packing capable of performing the above disclosed function. Such packing is well known in the art. An example of a currently available packing which can be employed in the present invention is 250Y FLEXIPAC® packing marketed by Koch-Glitsch of Wichita, Kans. The plurality of fixed valve trays in the lower portion of ammonia absorber 110 are designed to handle pressure excursions related to start-up and operation of the HCN synthesis system 100.

In a further embodiment, the temperature of the ammonia absorber 110 is maintained, at least in part, by withdrawing a portion of liquid from a lower portion of ammonia absorber 110 and circulating it through a cooler and back into ammonia absorber 110 at a point above the withdrawal point.

In some embodiments, the phosphate stream may comprise an aqueous solution of mono-ammonium hydrogen phosphate (NH₄H₂PO₄) and di-ammonium hydrogen phosphate ((NH₄)₂HPO₄). The phosphate stream may range in temperature from 0° C. to 150° C., e.g., from 0° C. to 110° C. or from 0° C. to 90° C.

In some embodiments, ammonia stream 112 comprises a substantial amount of the ammonia from the reactor effluent, e.g., greater than 50 wt. %, greater than 70 wt. %, or greater than 90 wt. %. Ammonia stream 112 may be further separated, purified and/or processed, as generally depicted by box 113, to recover the ammonia for recycle to the reactor feed.

In preferred embodiments, hydrogen cyanide stream 111 comprises less than 1000 mpm ammonia, e.g., less than 700 mpm, less than 500 mpm, or less than 300 mpm.

The ammonia scrubber 120 is designed to remove substantially all of the free ammonia present in the hydrogen cyanide stream 111 before the scrubber overhead stream 121 exiting scrubber 120 enters the HCN absorber 130. The scrubber overhead stream 121 should be substantially free of ammonia because free ammonia, (i.e. un-neutralized ammonia), will raise the pH in the HCN refining system 100, thus increasing the potential for HCN polymerization. Scrubber residue stream 122 comprises ammonia and may be recycled to ammonia absorber 110.

Although acids such as sulfuric acid can be used for HCN refining, a single acid, specifically phosphoric acid, is used in the HCN refining system 100 for producing uninhibited HCN. Concentrated phosphoric acid, such as 73 wt % aqueous phosphoric acid, can be added to maintain the desired pH. Generally the pH in a scrubber tails stream 122 is maintained from 1.7 to 2.0. The amount of phosphoric acid present in the dilute phosphoric acid stream can vary and will depend to a large degree on the amount of ammonia present in the hydrogen cyanide stream 111. Generally, however, the dilute phosphoric acid stream contains from 5.5 to 7.0 wt % free phosphoric acid.

An overhead scrubber stream 121 of the ammonia scrubber 120 contains HCN, water, carbon monoxide, nitrogen, hydrogen, carbon dioxide and methane. In one embodiment, the overhead scrubber stream 121 is fed to a partial condenser (not shown) where it is cooled with cooling water to a temperature of about 40° C. to form a cooled vapor stream and a condensed liquid stream. Dilute phosphoric acid can be sprayed into the condenser and into the cooled vapor stream in order to inhibit HCN polymerization. The condensed liquid stream and the cooled vapor stream are fed independently to an HCN absorber lower portion for HCN recovery.

Overhead scrubber stream 121 is directed to HCN absorber 130 where overhead scrubber stream 121 is separated to form off-gas stream 131 and HCN product 132. The off-gas stream 131 may contain carbon monoxide, nitrogen, hydrogen, carbon dioxide, oxygen and methane. The oxygen content of off-gas stream 131 may be measured using sensor 133, as described herein, and when the oxygen content is greater than 2 vol. %, the reaction assembly may be flushed with inert gas. As described herein, the oxygen threshold in the off-gas stream is higher than in the crude hydrogen cyanide product because the off-gas stream is more concentrated than the crude hydrogen cyanide product. The main fuel components are hydrogen and carbon monoxide with some methane. The off-gas stream 131 may be flared, or may be used as a boiler fuel in steam producing boilers in order to recover energy. By utilizing the off-gas stream as a fuel, not only is steam generated, but any residual HCN in the off-gas is also destroyed. In addition, if the hydrogen concentration is economically recoverable, such as when the oxygen-containing gas comprises greater than 21 vol. % oxygen, the off-gas stream 131 can first be sent to a hydrogen recovery unit, such as a pressure-swing adsorber unit, to recover high purity hydrogen.

A comparison of the off-gas stream 131 after separation from the crude hydrogen cyanide product 107, for the oxygen Andrussow process and for the air Andrussow process is tabulated below in Table 1.

TABLE 1
COMPARISON OF HCN OFF-GAS STREAM COMPOSITIONS

| Nominal Composition, | Oxygen Andrussow | |
|---|---|---|
| vol. % | Process | Air Andrussow Process |
| H₂ | 80.1 | 16.61 |
| N₂ | 5.6 | 76.32 |
| CO | 11.0 | 4.44 |
| AR | 0.2 | 0.48 |
| O₂ | 0.2 | — |
| CH₄ | 1.6 | 0.83 |
| CO₂ | 0.8 | 0.29 |
| NH₃ | — | — |
| HCN | 0.1 | 0.11 |
| Other nitriles | Trace | 0.01 |
| H₂O | 0.4 | 0.91 |

As shown in Table 1, when an oxygen Andrussow Process is used, the off-gas stream 131 comprises 0.2 vol. % oxygen and 5.6 vol. % nitrogen. If the vol. % oxygen in the ternary gas mixture increases, there will be a concomitant increase in oxygen concentration in the off-gas stream. As described herein, when this oxygen content reaches 2 vol. %, the reaction assembly will be flushed with inert gas to reduce the oxygen content in the reaction assembly, and thus in the crude hydrogen cyanide product and in the off-gas stream.

In one embodiment, the threshold of oxygen in the off-gas stream may be used to control hydrogen recovery using a pressure swing adsorber (“PSA”). As shown in Table 1, the hydrogen concentration in the off-gas stream is much higher when using pure oxygen as the oxygen-containing gas than when using air. Because of this high concentration of hydrogen in the off-gas, the hydrogen may be recovered in a high purity hydrogen stream and used in further processes, resulting in substantial cost savings in those further processes. The sensor to measure oxygen content of the off-gas stream may also be used to set an oxygen threshold for diverting the off-gas stream from the PSA. This threshold may be 1 vol. % or greater oxygen, e.g., 0.8 vol. % of greater, or 0.6 vol. % or greater.

The hydrogen cyanide product in line 132 may be sent to an HCN enricher column (not shown) to recover anhydrous HCN, and may be used as a source of HCN in future processes, such as for hydrocyanation. The term “hydrocyanation” as used herein is meant to include hydrocyanation of aliphatic unsaturated compounds comprising at least one carbon-carbon double bond or at least one carbon-carbon triple bond or combinations thereof, and which may further comprise other functional groups including, but not limited to, nitriles, esters, and aromatics. Examples of such aliphatic unsaturated compounds include, but are not limited to, alkenes (e.g., olefins); alkynes; 1,3-butadiene; and pentenenitriles. The purified uninhibited HCN produced by the herein disclosed and/or claimed inventive process(es), methodology(ies), apparatus(es) and composition(s) is suitable for hydrocyanation as stated above, including 1,3-butadiene and pentenenitrile hydrocyanation to produce adiponitrile (ADN). ADN manufacture from 1,3-butadiene involves two synthesis steps. The first step uses HCN to hydrocyanate 1,3-butadiene to pentenenitriles. The second step uses HCN to hydrocyanate the pentenenitriles to adiponitrile (ADN). This ADN manufacturing process is sometimes referred to herein as hydrocyanation of butadiene to ADN. ADN is used in the production of commercially important products including, but not limited to, 6-aminocapronitrile (ACN); hexamethylenediamine (HMD); epsilon-caprolactam; and polyamides such as nylon 6 and nylon 6,6.

Various control systems may be used to regulate the reactant gas flow by measuring oxygen concentrations and activating inert gas blanketing system. For example flow meters that measure the flow rate, temperature, and pressure of the reactant gas and allow a control system to provide “real time” feedback of pressure- and temperature-compensated flow rates to operators and/or control devices may be used. As will be appreciated by one skilled in the art, the foregoing functions and/or process may be embodied as a system, method or computer program product. For example, the functions and/or process may be implemented as computer-executable program instructions recorded in a computer-readable storage device that, when retrieved and executed by a computer processor, controls the computing system to perform the functions and/or process of embodiments described herein. In one embodiment, the computer system can include one or more central processing units, computer memories (e.g., read-only memory, random access memory), and data storage devices (e.g., a hard disk drive). The computer-executable instructions can be encoded using any suitable computer programming language (e.g., C++, JAVA, etc.). Accordingly, aspects of the present invention may take the form of an entirely software embodiment (including firmware, resident software, micro-code, etc.) or an embodiment combining software and hardware aspects.

From the above description, it is clear that the present invention is well adapted to carry out the objects and to attain the advantages mentioned herein as well as those inherent in the presently provided disclosure. While preferred embodiments of the present invention have been described for purposes of this disclosure, it will be understood that changes may be made which will readily suggest themselves to those skilled in the art and which are accomplished within the spirit of the present invention.

The invention can be further understood by reference to the following examples.

### Example 1

A ternary gas mixture is formed by combining pure oxygen, an ammonia-containing gas and a methane-containing gas. The ammonia-to-oxygen molar ratio in the ternary gas mixture is 1.3:1 and the methane-to-oxygen ratio in the ternary gas mixture is from 1.2:1. The ternary gas mixture, which comprises from 27 to 29.5 vol. % oxygen, is reacted in the presence of a platinum/rhodium catalyst to form a crude hydrogen cyanide product. A gas sensor is present to measure oxygen content in the crude hydrogen cyanide product prior to entering the ammonia and the HCN separation trains. The sensor uses gas chromatography to measure the oxygen content. The sensor reports an oxygen content of 0.5 vol. %, indicating system upset, and the inert gas blanketing system is activated. The inert gas is nitrogen. A conduit for directing the oxygen-containing gas to the reactor has two valves, a first oxygen valve and a second oxygen valve, in series, with the second oxygen valve being downstream and closer to the reactor inlet. The oxygen valves are comprised of stainless steel. The oxygen flow is ceased by closing a first oxygen valve, concurrent with nitrogen being released from pressurized storage tanks. The nitrogen flows through the oxygen inlet pipe in two locations. The first location is between the first oxygen valve and a second oxygen valve. The second location is between the second oxygen valve and the reactor inlet. Methane and ammonia feeds continue to the reactor uninterrupted. Concurrent with the oxygen flow ceasing, a control valve is activated to cease the flow from the reactor outlet to the ammonia and HCN separation trains. The control valve comprises graphite and stainless steel. The control valve is free of polytetrafluoroethylene. A vent valve, comprised of the same materials as the control valve, is opened to direct the flow from the reactor outlet to a flare. System equilibrium is restored and the process may be restarted. The pressurized nitrogen provides a sufficient volume of nitrogen to purge oxygen from the reactor in the event of power failure.

### Example 2

A crude hydrogen cyanide product is produced as in Example 1. The crude hydrogen cyanide product is directed through an ammonia absorber, an ammonia scrubber and an HCN absorber to form an off-gas stream. The sensor is present to measure the oxygen content in the off-gas stream. The sensor reports an oxygen content of greater than 2 vol. %, indicating system upset, and the inert gas blanketing system is activated. The inert gas blanketing system is run as in Example 1.

### Comparative Example A

The process is followed as in Example 1, except that the control valve and release valve consist of polytetrafluoroethylene. Each valve deforms upon activation, i.e. when contacted with the crude hydrogen cyanide product. The flow from the reactor outlet is only partially directed to a flare and system equilibrium is not restored.

1-15. (canceled)

16. A process for producing hydrogen cyanide, comprising:
introducing components of the ternary gas mixture to a mixing vessel included in a reaction assembly to form a ternary gas mixture comprising at least 25 vol. % oxygen;
contacting the ternary gas mixture with a catalyst to provide a crude hydrogen cyanide product;
flushing the reaction assembly with an inert gas when the crude hydrogen cyanide product comprises more than a threshold of oxygen; and
diverting the crude hydrogen cyanide product from separation process equipment by activating at least one valve consisting of materials that can withstand a temperature of greater than 200° C.

17. The process of claim 16, wherein the threshold of oxygen is greater than 0.4 vol. %.

18. The process of claim 16, wherein the components of the ternary gas mixture comprise an oxygen-containing gas, a methane-containing gas and an ammonia-containing gas.

19. The process of claim 18, wherein the oxygen-containing gas comprises at least 80 vol. % oxygen.

20. The process of claim 18, wherein the oxygen-containing gas comprises pure oxygen.

21. The process of claim 18, wherein the flushing comprises stopping the oxygen-containing gas flow and flushing the reaction assembly with the inert gas.

22. The process of claim 21, wherein the oxygen-containing gas flow is ceased by activating a valve.

23. The process of claim 16, wherein the ternary gas mixture comprises from 25 vol. % to 32 vol. % oxygen.

24. The process of claim 16, wherein the at least one valve is comprised of graphite and stainless steel.

25. The process of claim 16, wherein the at least one valve can withstand a pressure of 14 MPa.

26. The process of claim 16, wherein the inert gas is selected from the group consisting of nitrogen, helium, carbon dioxide, argon and mixtures thereof.

27. The process of claim 16, wherein the inert gas is nitrogen.

28. The process of claim 16, wherein the threshold of oxygen is measured using a sensor.

29. The process of claim 16, wherein the threshold of oxygen is further measured in an off-gas stream, and wherein the threshold of oxygen in the off-gas stream is higher than the threshold of oxygen in the crude hydrogen cyanide product.

30. A process for producing hydrogen cyanide, comprising:
introducing components of the ternary gas mixture to a mixing vessel included in a reaction assembly to form a ternary gas mixture comprising at least 25 vol. % oxygen;
contacting the ternary gas mixture with a catalyst to provide a crude hydrogen cyanide product;
separating the crude hydrogen cyanide product to form an off-gas stream and a hydrogen cyanide product stream;
flushing the reaction assembly with an inert gas when the off-gas stream comprises more than 1 vol. % oxygen; and
diverting the crude hydrogen cyanide product from separation process equipment by activating at least one valve that is free of polytetrafluoroethylene.

31. The process of claim 30, wherein the components of the ternary gas mixture comprise an oxygen-containing gas, a methane-containing gas and an ammonia-containing gas.

32. The process of claim 30, wherein the oxygen-containing gas comprises at least 80 vol. % oxygen.

33. The process of claim 30, wherein the oxygen-containing gas comprises pure oxygen.

34. A reaction assembly for producing hydrogen cyanide, the reaction assembly comprising:
an inert gas storage unit;
a mixing vessel comprising a first inlet port for ternary gas mixture components comprising a methane-containing gas, an ammonia-containing gas, and the oxygen-containing gas;
a reactor comprising a second inlet port, at least one outlet port, and an internal reaction chamber comprising a catalyst bed containing a catalyst; and
a crude hydrogen cyanide product diverting valve that is free of polytetrafluoroethylene;
wherein the inert gas storage unit is configured to be maintained in a pressure of 1300 to 1600 kPa and can feed an inert gas to the mixing vessel.

35. The reaction assembly of claim 34, further comprising at least one sensor connected to the at least one outlet port for measuring the oxygen content.
